(19) United States
(12) Patent Application Publication
(10) Pub. No.: US 2016/0097519 A1
(43) Pub. Date: Apr. 7, 2016

(54) METHOD AND APPARATUS FOR DECORATIVE LIGHTING

(71) Applicant: ROBERT M. WISE, UNIONTOWN, OH (US)

(72) Inventor: ROBERT M. WISE, UNIONTOWN, OH (US)

(21) Appl. No.: 14/875,997

(22) Filed: Oct. 6, 2015

Related U.S. Application Data
(60) Provisional application No. 62/060,217, filed on Oct. 6, 2014.

(51) Int. Cl. F21V 21/22; F21V 23/02; F21V 23/00; F21V 21/30

(52) U.S. Cl. CPC F21V 21/22; F21V 21/30; F21V 23/02; F21V 23/003; F21W 2121/00

(57) ABSTRACT

A decorative lighting apparatus is described herein, having a frame, the frame having a base, two side members, and multiple cross members, multiple, adjustably rotatable laser lights, wherein the laser lights are mounted on the cross members, wherein the laser lights are removably attached to the cross members, multiple brackets, wherein the laser lights are attached to the cross members by the brackets, and a power supply operatively connected to the laser lights, wherein the laser lights are infinitely configurable around the frame.

### I. BACKGROUND

This application claims priority to a provisional patent application, Ser. No. 62/060,217, filed Oct. 6, 2014, the contents of which are incorporated herein by reference. This disclosure pertains to the art of laser-based decorative lighting. Houses are frequently decorated for holidays by attaching strings of decorative lights to the houses. To simplify installation and removal, improve safety, reduce fire hazards, and reduce damage risk, this method and apparatus is disclosed.

### II. SUMMARY

In accordance with one aspect of the present teaching, a decorative lighting apparatus includes a frame and at least one laser light secured to the frame.

In accordance with another aspect of the present teaching, a method of decorating an object includes the steps of: a) providing a decorative lighting apparatus; b) directing the at least one laser light at the object; and c) supplying power to the at least one laser light.

Still other benefits and advantages of the present teaching will become apparent to those skilled in the art to which it pertains upon a reading and understanding of the following detailed specification.

### III. BRIEF DESCRIPTION OF THE DRAWINGS

Example arrangements are described hereinafter with reference to the accompanying drawings.

FIG. 1 is a perspective view of a house illuminated according to one embodiment;

FIG. 2 is a front view of a house illuminated according to another embodiment;

FIG. 3 is a front perspective view of a decorative lighting apparatus according to one embodiment; and,

FIG. 4 is a close-up front perspective view of a decorative lighting apparatus according to one embodiment.

### IV. DETAILED DESCRIPTION

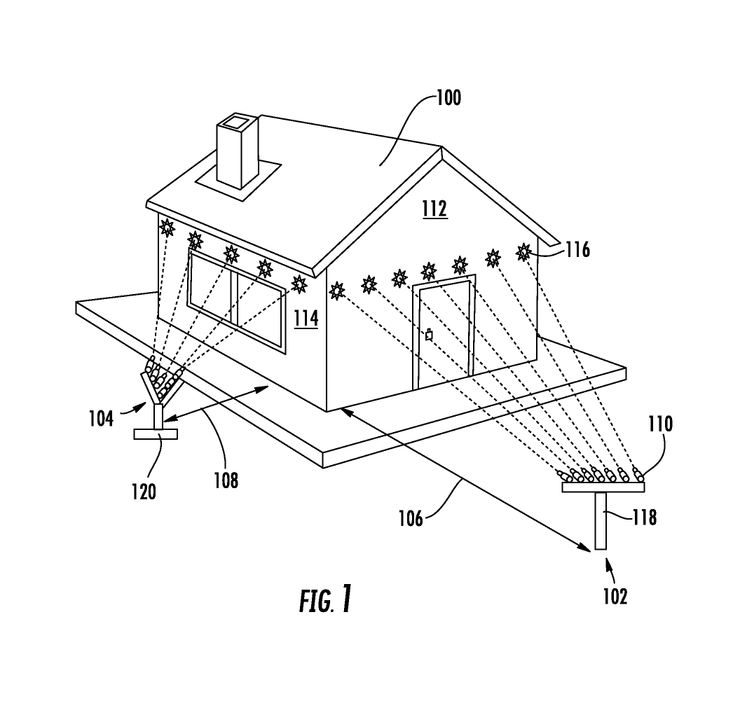

Referring now to the drawings wherein the showings are for purposes of illustrating the present teachings, and not for purposes of limiting the same, and wherein like reference numerals are understood to refer to like components, FIG. 1 shows a house 100 illuminated according to one embodiment with two illuminating decorative lighting apparatuses 102, 104. While a house 100 is shown and discussed in the specification and drawings, the decorative lighting apparatus may be used in alternative embodiments with other buildings (including, but not limited to, commercial, residential, industrial, agricultural, marine, and institutional), fixed structures, and other fixed objects (including, but not limited to, fences, towers, trees, and bushes). Alternative embodiments of the present teachings may also be used with non-fixed objects (including, but not limited to, land vehicles, aircraft, watercraft, and tents) where the distances between the lighting apparatuses and the objects are substantially constant. Alternative embodiments may also be used with non-fixed objects where the distances between the lighting apparatuses and the objects are not constant.

FIG. 1 shows a decorative lighting apparatus 102 according to one embodiment. This apparatus 102 may include at least one laser light 110. In alternative embodiments, this apparatus 102 may include a plurality of laser lights 110. The embodiment of the apparatus 102 shown in FIG. 1 includes seven laser lights 110. By using lasers, the decorative lighting apparatus may reduce the amount of energy required to decorate a house 100 with lights compared to traditional decorative lighting, which often uses incandescent lights. In one embodiment, the lasers used in the laser lights 110 may be similar to those used in laser pointers.

The apparatus 102 may be stationed a distance 106 from the house 100, directing its laser lights 110 at a wall or surface 112 of the house 100. When the light from a laser light 110 reaches the surface 112 onto which the light is directed, the light may cause an illumination 116 to appear on the surface 112. Each separate laser light 110 may cause a separate such illumination 116. If the laser lights 110 are pointed to different locations on the surface 112 or to different surfaces, the illuminations 116 may be seen as separate illuminations 116. If the laser lights 110 are pointed at the same location, the illuminations 116 may be seen as one illumination 116. FIG. 1 shows seven separate laser lights 110 of the apparatus 102 pointing to seven different locations on the surface 112 of the house 100 to create seven separate illuminations 116 at those different locations. The dashed lines on FIG. 1 represent the path of travel for the light.

FIG. 1 also shows another decorative lighting apparatus 104 according to another embodiment. In alternative embodiments, as many decorative lighting apparatuses may be used for each illuminated house 100 as desired. In one embodiment, each side of a house 100 may be illuminated. In another embodiment, only some sides of a house 100 may be illuminated. In another embodiment, only the side(s) of the house visible from a public road may be illuminated. In alternative embodiments, one or a plurality of decorative lighting apparatuses may be used per side of a house 100 or per surface of a house.

In alternative embodiments, the decorative lighting apparatuses may be used outdoors or indoors to decorate outside or inside surfaces. The individual laser lights 110 of one decorative lighting apparatus may be pointed at different surfaces or at the same surface, in alternative embodiments. The decorative lighting apparatus may cause illuminations 116 to appear on horizontal surfaces, vertical surfaces, angled surfaces, flat surfaces, and non-flat surfaces in any desired orientation by proper positioning of the apparatus.

The decorative lighting apparatus 104 shown in FIG. 1 include five laser lights 110. However, this apparatus 104 (or any other decorative lighting apparatus) may include one or a plurality of laser lights 110 as desired, in alternative embodiments.

The decorative lighting apparatus 104 may be stationed a distance 108 from the house 100, directing its laser lights 110 at a wall or surface 114 of the house 100 and causing illuminations 116 to appear on the surface 114 at the locations at which the laser lights 110 are directed. FIG. 1 shows five separate illuminations 116 created on the surface 114 by the apparatus 104. The illuminations 116 may be configured to appear in a row as shown in FIG. 1, but they 116 do not have to be. In alternative embodiments, the decorative lighting apparatus 102, 104 may have its laser lights 110 configured such that the illuminations 116 form a desired shape, including, but not limited to, a cross, a star, or a circle.

The distance 106, 108 may be varied in alternative embodiments. For example, FIG. 1 shows that the distance 106 between one lighting apparatus 102 and the surface 112 onto which the apparatus 102 directs its illuminations 116 may be greater than the distance 108 between another lighting apparatus 104 and the surface 114 onto which the other apparatus 104 directs its illuminations 116.

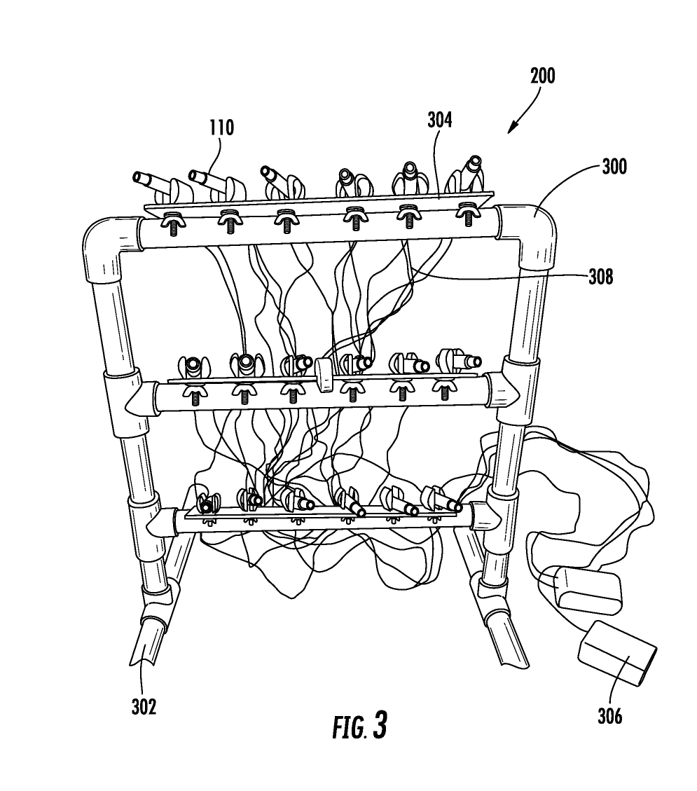

Alternative embodiments of decorative lighting apparatuses may have frames of various configurations, shapes, and sizes. In one embodiment, apparatus 102 may have a generally T-shaped frame 118, as shown in FIG. 1. In another embodiment, apparatus 104 may have a generally Y-shaped frame 120, as shown in FIG. 1. FIG. 3 shows yet another embodiment of a decorative lighting apparatus 200 and its frame 300. The frames in alternative embodiments may be designed as necessary to support the desired laser lights 110. In alternative embodiments, frames may be single-level, such as the frame 118 shown in FIG. 1, or multi-level, such as the frame 300 shown in FIG. 3. In alternative embodiments, frames may include parallel mounting surfaces, such as the frame 300 shown in FIG. 3, or non-parallel mounting surfaces, such as the frame 120 shown in FIG. 1.

In alternative embodiments, a decorative lighting apparatus 102, 104, 200 may be permanently installed or may be temporarily placed in the desired location. In one embodiment, an example of which is shown in FIG. 1, an apparatus 104 may have a base (attached to or formed as part of its frame 120) that aids in the stable placement of the apparatus 104. Such an apparatus 104 with such a base may simply be placed on a supporting surface. In another embodiment, an example of which is shown in FIG. 1, an apparatus 102 may have a base that is designed to be installed or secured inside a supporting surface. For example, the apparatus 102 may have the base of its frame 118 buried into the ground to support and fix the apparatus 102. In alternative embodiments, a decorative lighting apparatus 102, 104, 200 may be placed on the ground or secured above ground. Alternative embodiments of the decorative lighting apparatus 102, 104, 200 may include adjustable frames or bases, allowing the height, position, orientation, or configuration of the apparatus to be adjusted. In different embodiments, the frame may be made of a lightweight material, such as, for example, polymer or aluminum.

The decorative lighting apparatus 102, 104, 200 may be used to decorate a house 100. In one embodiment, the apparatuses may create illuminations 116 that simulate traditional decorative strings of lights affixed to a house 100. In one embodiment, the apparatuses may be used to decorate a house 100 for holidays, such as, but not limited to, Christmas, New Year's, Easter, and Halloween. In another embodiment, the decorative lighting apparatus may be used in conjunction with traditional decorative lighting.

In one embodiment, the laser lights 110 may create steady illuminations 116. In another embodiment, the laser lights 110 may create blinking illuminations 116. In another embodiment, the laser lights 110 may be timed or programmed to blink such that the illuminations 116 simulate “running” lights. In one embodiment, the laser lights 110 of an apparatus may all emit one color. In another embodiment, the laser lights 110 of an apparatus may each emit a different color. In alternative embodiments, the laser light 110 may create an illumination 116 in a desired shape, including, but not limited to, a cross, a circle, and a star.

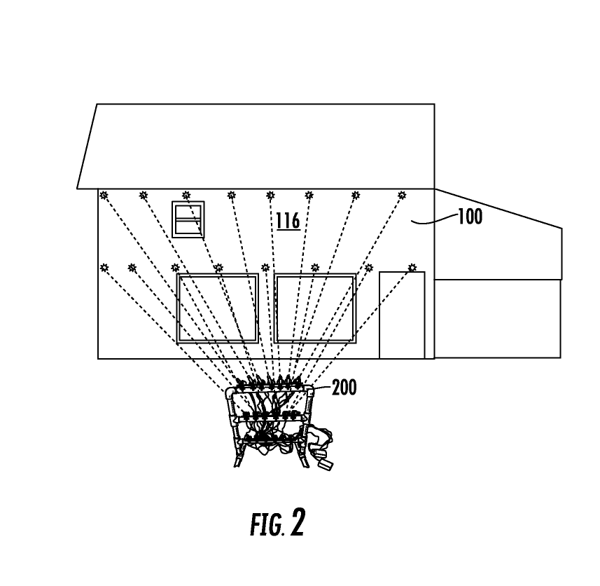

FIG. 2 shows a front view of a house 100 illuminated with another decorative lighting apparatus 200, according to another embodiment. This apparatus 200 may be positioned in front of the house 100 and create eighteen illuminations 116 in two rows on the front of the house. The surface on which the upper row of illuminations 116 appears in FIG. 2 is further away from apparatus 200 than the surface on which the lower row of illuminations 116 appears. The apparatus 200 may be positioned on the front yard before the house 100.

FIG. 3 shows the decorative lighting apparatus 200 of FIG. 2. The apparatus 200 may have a frame 300 generally shaped as a figure “8.” Attached to the bottom of the frame 300 may be a base 302, which may support the apparatus 200 on a surface. The apparatus 200 may have a plurality of laser lights 110 secured to it 200. In one embodiment, a frame 300 may have at least one mounting plate 304 secured to it 300. FIG. 3 shows an embodiment with three mounting plates 304. The plurality of laser lights 110 may be secured to the mounting plate 304. In one embodiment, each level of laser lights may 110 be independently adjusted for height.

In alternative embodiments, a laser light 110 may be powered by a battery or by an external power source. In the embodiment shown in FIG. 3, each laser light 110 is connected by a conductor 308 to a power supply adapter 306 that is connected to a power supply. The power supplied to each laser light 110 may be as required for the laser light 110 to operate. In one embodiment, a laser light 110 uses a 1-5 mW laser. In one embodiment, a laser light 110 is nominally rated for 5 Vdc. In one embodiment, the power supply adapter 306 may be a universal adapter, converting an input voltage from 90-240 Vac into the required DC voltage for the laser light 110. In one embodiment, the power supply adapter 306 may be rated to output a maximum of 800 mAdc.

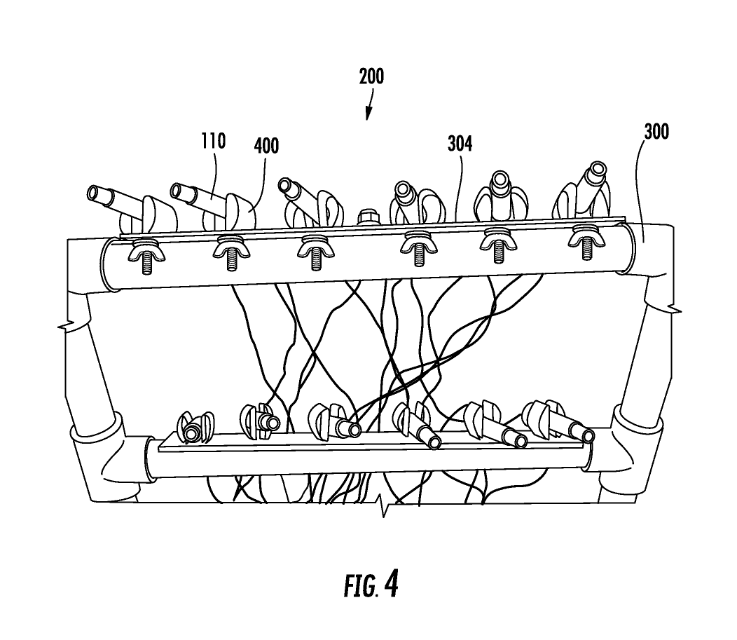

FIG. 4 shows a close-up view of the decorative lighting apparatus 200 shown in FIG. 3. In one embodiment, each laser light 110 may be secured to the frame 300 using a clamp, holder, or bracket 400. The bracket 400 may be secured to the mounting plate 304, in one embodiment. FIG. 4 shows each bracket 400 secured to the mounting plate 304 using a bolt and wing nut (although it is to be understood that any method of attaching the laser lights 110 to the frame 300 can be used). The bracket 400 may allow proper, independent aiming and positioning of the laser light 110 to create the desired illumination 116. In an alternative embodiment, individual laser lights 110 may be added to or removed from a decorative lighting apparatus as desired. In another embodiment, individual laser lights 110 of an apparatus may be turned on or off as desired.

Alternative embodiments may include a controller. The controller may allow the laser lights 110 to blink, as previously discussed. The controller may also turn the laser lights 110 on and off based on a pre-defined time schedule, in one embodiment. In another embodiment, the controller may also turn the laser lights 110 on and off as triggered by a sensor, such as, but not limited to, a photodetector. In one embodiment, if the ambient light is below a certain threshold (e.g., in the evening and nighttime), the controller may turn on the laser lights 110; if the ambient light increases above a certain threshold (e.g., during the day), the controller may turn off the laser lights 110. Such a controller may conserve power and increase the life of the decorative lighting apparatus. Another embodiment may include a remote control that allows the apparatus to be turned on and off remotely.

Because a decorative lighting apparatus may be simply placed on the ground, a user may dispense with climbing at a height to install or hang traditional decorative lighting strings on a house 100, which may improve safety and reduce fall risks. Furthermore, because the decorative lighting apparatus may shine illuminations 116 onto a house 100 without physically contacting the house 100 (unlike traditional decorative lighting), the risk of damaging surfaces of the house 100 due to contact may be reduced. Additionally, because the decorative lighting apparatus may decorate the house 100 without physically contacting it, the risk of fire may be lower than for traditional decorative lighting.

Various embodiments of the decorative lighting apparatus may be set up without requiring special tools, hangers, or clips. The installation of the decorative lighting apparatus may be intuitive to, and easy to understand by, a user of almost any age. A user may simply place a decorative lighting apparatus at a proper location away from a house 100 and aim each laser light 110 appropriately, which may result in a much shorter installation time and removal time compared to traditional decorative lighting that is physically positioned at various locations around the house 100. Furthermore, because long strings of traditional decorative lighting are not required, the need to untangle such strings may be reduced or eliminated by the use of the decorative lighting apparatus. Decorating a house 100 with a decorative lighting apparatus may be easier than with traditional decorative lighting because the apparatus may have a plurality of individual independently aimed laser lights 110 adjustable in multiple directions from one static location.

Numerous embodiments have been described, hereinabove. It will be apparent to those skilled in the art that the above methods and apparatuses may incorporate changes and modifications without departing from the general scope of the present teachings. It is intended to include all such modifications and alterations in so far as they come within the scope of the appended claims or the equivalents thereof.

I/We claim:

1. A decorative lighting apparatus, the apparatus comprising:
a frame, the frame having a base, two side members, and multiple cross members;
multiple, adjustably rotatable laser lights, wherein the laser lights are mounted on the cross members, wherein the laser lights are removably attached to the cross members;
multiple brackets, wherein the laser lights are attached to the cross members by the brackets; and,
a power supply operatively connected to the laser lights, wherein the laser lights are infinitely configurable around the frame.

2. A decorative lighting apparatus, the apparatus comprising:
a frame, the frame having a base, and at least one cross member;
multiple, adjustably rotatable laser lights, wherein the laser lights are mounted on the at least one cross member; and,
a power supply operatively connected to the laser lights.

3. The apparatus of claim 2, wherein the at least one cross member forms a T-shape with the frame.

4. The apparatus of claim 2, wherein the at least one cross member forms a Y-shape with the frame.

5. The apparatus of claim 2, wherein the frame has two side members, and the at least one cross member is substantially perpendicular to the two side members.

6. The apparatus of claim 2, wherein the frame is adjustable for height and width.

7. The apparatus of claim 6, wherein the laser lights can rotate at least 180 degrees both horizontally and vertically.

8. The apparatus of claim 7, wherein the laser lights infinitely configurable.

9. The apparatus of claim 8, wherein the power supply is internal to the apparatus.

10. The apparatus of claim 9, wherein the laser lights can pulse on and off and any frequency.

11. The apparatus of claim 2, wherein the apparatus further comprises a controller, for controlling the laser lights.

12. The apparatus of claim 11, wherein the controller can adjust alter the frequency of the laser lights.

13. The apparatus of claim 11, wherein the controller has a sensor, wherein the sensor can automatically turn the laser lights on and off based on data received by the sensor.

14. The apparatus of claim 13, wherein the laser lights use a 1-5 mW laser.

15. The apparatus of claim 14, wherein the laser lights are rated for 5 Vdc.

16. A method of decoratively lighting an object, the method comprising the steps of:
providing a frame, multiple, adjustably rotatable laser lights, and a power supply;
turning on the laser lights; and,
configuring the laser lights such that the laser lights mimic the appearance of corded lights on the object.

17. The method of claim 16, wherein the method further comprises the step of:
configuring the laser lights, such that light from the laser lights projected on the object form a shape chosen from the following group: straight line, curved line, a cross, a circle, Christmas tree, oval, square, rectangle, star, or polygon.

18. The method of claim 17, wherein the laser lights use a 1-5 mW laser.

19. The method of claim 18, wherein the laser lights are rated for 5 Vdc.
